(19) United States
(12) Patent Application Publication
(10) Pub. No.: US 2010/0207410 A1
(43) Pub. Date: Aug. 19, 2010

(54) Opposed Spring-Loaded Anchor Hook Supporting Device

(75) Inventor: Robert L. LEON, Ambler, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: LIFE-PACK TECHNOLOGIES, INC., Willow Grove, PA (US)

(21) Appl. No.: 12/694,769

(22) Filed: Jan. 27, 2010

Related U.S. Application Data
(60) Provisional application No. 61/207,999, filed on Feb. 19, 2009.

(51) Int. Cl. B66C 1/34

(52) U.S. Cl. 294/82.1

(57) ABSTRACT

An anchor hook supporting device is for use with an anchor hook having a hook end for engaging a first surface of a support member and a shank end which includes an eyelet opening for receiving a rope or cable. The supporting device includes an attachment assembly for being secured to the shank end of the anchor hook and an engagement assembly for engaging one of a second surface of the support member and another surface which is fixed with respect to the support member. A biasing member having a first end secured to the attachment assembly and a second end secured to the engagement assembly biases the engagement assembly toward the attachment assembly to bias the shank end of the anchor hook and the engagement assembly toward each other for holding the hook end of the anchor hook on the first surface of the support member and the engagement assembly on the second surface of the support member or the other surface.

### CROSS REFERENCE TO RELATED APPLICATIONS

This application claims priority from U.S. Provisional Patent Application No. 61/207,999 filed Feb. 19, 2009 and entitled “Opposed Spring-Loaded Anchor Supporting Device,” the subject matter of which is hereby incorporated herein by reference.

### BACKGROUND OF THE INVENTION

The present invention relates generally to an anchor, such as an open hook anchor of the type used by firefighters and, more particularly to an opposed, spring-loaded supporting device for maintaining such an anchor hook in place on an a window sill or other engaged support member. The present invention is particularly useful in assisting public safety workers such as firefighters, rescue workers and the like in performing their duties and/or in escaping from dangerous locations, such as a high floor of a burning building.

When a firefighter, rescue worker or other public service worker enters a dangerous location, such as a burning multi-story building, he or she could become trapped by the fire on an upper floor from which the only escape may be out of a window. Accordingly, firefighters, rescue workers and other public service workers often carry a personal escape system which typically includes a long rope or cable with an anchor hook or similar device on one end for anchoring the end of the rope or cable to a support member at or near the window, for example a window sill, prior to the escape. Today's most commonly used anchor hook for such escape systems is an open hook 12, illustrated in FIG. 1, which was specifically developed for this purpose by the New York City fire department (FDNY) and which is manufactured and distributed by the Crosby Company. During the firefighter's descent from the window, his or her weight on the rope or cable which pulls on the shank end of the anchor hook is usually sufficient to keep the anchor hook in place hooked to or engaging the window sill or other such supporting member.

The problem is to keep the anchor hook in place on the window sill when the firefighter's weight is not on the anchor hook, e.g., while he or she is exiting the window or while he or she is being recovered at a lower floor window or landing or on the ground. In the latter situations, although the firefighter may no longer need the support provided by the anchor hook, if the anchor hook becomes dislodged from the window sill or other such support member it could fall onto the firefighter or others with potentially lethal results. Moreover, a raging fire licking at an escaping firefighter's heels (or worse) is likely to result in some panic, so that he or she may not be able to exit the window and continue to maintain sufficient tension on the rope or cable to hold the anchor hook in place on the window sill at the same time. To avoid a potentially catastrophic result in this type of situation, a device is needed to keep the anchor hook in place on the window sill or other support member when no weight is applied to the rope or cable, so the firefighter can concentrate on getting out of the window and down to safety without having to worry about keeping the anchor hook from dislodging from the window sill or other support member.

The present invention comprises an opposed spring-loaded anchor hook supporting device which maintains tension on the anchor hook to keep both the supporting device and the anchor hook in place on the window sill or other support member through the entire escape process—while the firefighter exits through the window opening, while the firefighter descends to a safe lower level, and while the firefighter is recovered at a lower floor, landing or on the ground. The supporting device includes a pre-curled constant force spring that exerts a substantially constant spring force on the shank of the anchor hook near the rope or cable attachment point such that when the anchor hook is positioned on the window sill or other support member and the supporting device is also affixed to the sill or other support member in the general exiting direction of the rope or cable, the spring force keeps the anchor hook in place. Although the firefighter escape application is discussed in the below detailed description section as the preferred embodiment, the broad inventive concepts are applicable to other related and unrelated applications.

### BRIEF SUMMARY OF THE INVENTION

Briefly stated, in one embodiment, the present invention comprises an anchor hook supporting device for use with an anchor hook having a hook end for engaging a first surface of a support member and a shank end which includes an eyelet opening for receiving a rope or cable. The supporting device comprises an attachment assembly for being secured to the shank end of the anchor hook and an engagement assembly for engaging one of a second surface of the support member, and another surface which is fixed with respect to the support member. A biasing member having a first end secured to the attachment assembly and a second end secured to the engagement assembly biases the engagement assembly toward the attachment assembly to bias the shank end of the anchor hook and the engagement assembly toward each other for holding the hook end of the anchor hook on the first surface of the support member and the engagement assembly on the second surface of the support member or the other surface.

In another embodiment the present invention comprises a combined anchor hook and supporting device for holding the anchor hook on a support member. The combination comprises an anchor hook having a hook end for engaging a first surface of the support member and a shank end which includes an eyelet opening for receiving a rope or cable and a supporting device comprising an attachment assembly secured to the shank end of the anchor hook, an engagement assembly for engaging one of a second surface of the support member and another surface which is fixed with respect to the support member and a biasing member having a first end secured to the attachment assembly and a second end secured to the engagement assembly. The biasing member biases the engagement assembly toward the attachment assembly to bias the shank end of the anchor hook and the engagement assembly toward each other for holding the hook end of the anchor hook on the first surface and the engagement assembly on the second surface of the support member or the other surface.

In yet another embodiment the present invention, comprises a method of securing an anchor hook to a support member comprising the steps of: providing an anchor hook having a hook end and a shank end which includes an eyelet opening for receiving a rope or cable; securing a supporting device to the anchor hook, the securing device including an attachment assembly secured to the shank end of the anchor hook, an engagement assembly and a biasing member having a first end secured to the attachment assembly and a second end secured to the engagement assembly, the biasing member biasing the engagement assembly toward the attachment assembly; placing the hook end of the anchor hook into engagement with a first surface of the support member; pulling the engagement assembly away from the attachment assembly against the bias of the biasing member; placing the engagement member into engagement with one of a second surface of the support member and another surface which is fixed with respect to the support member; and releasing the engagement member so that the biasing member biases the shank end of the anchor hook and the engagement member toward each other to hold the hook end of the anchor hook on the first surface of the support member and the engagement assembly on the second surface of the support member or the other surface.

### BRIEF DESCRIPTION OF THE DRAWINGS

The foregoing summary, as well as the following detailed description of the elements and physical principals of a preferred embodiment of the invention will be better understood when read in conjunction with the appended drawings. For the purpose of illustrating the invention, particular arrangements and methodologies are shown in the drawings and described below. It should be understood, however, that the invention is not limited to the precise arrangements shown or the methodologies of the detailed description. In the drawings:

FIG. 1 is an exploded perspective view of a combination standard anchor hook and an attached opposed spring-loaded anchor supporting device in accordance with a preferred embodiment of the invention to show component parts including an interconnecting constant-force spring, and the other components;

FIG. 2 is a side elevational view of the combination anchor hook and anchor supporting device of FIG. 1 in a folded or storage position;

FIG. 3 is a side elevational view similar to FIG. 2 with the combination anchor hook and anchor supporting device of FIG. 1 in an unfolded, ready-to-use position;

FIG. 4 is a perspective view of the combination anchor hook and anchor supporting device of FIG. 1 positioned across and engaged with a simulated wide window sill; and

FIGS. 5A thru 5F are fragmentary perspective views of a portion of the opposed spring-loaded anchor supporting device of FIG. 1 illustrating several potential positions for engaging the upper or lower corners of a simulated window sill or other support member.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the combination anchor hook and supporting device and designated parts thereof. Unless specifically set forth herein, the terms “a”, “an” and “the” are not limited to one element but instead should be read as meaning “at least one”. The terminology includes the words noted above, derivatives thereof and words of similar import.

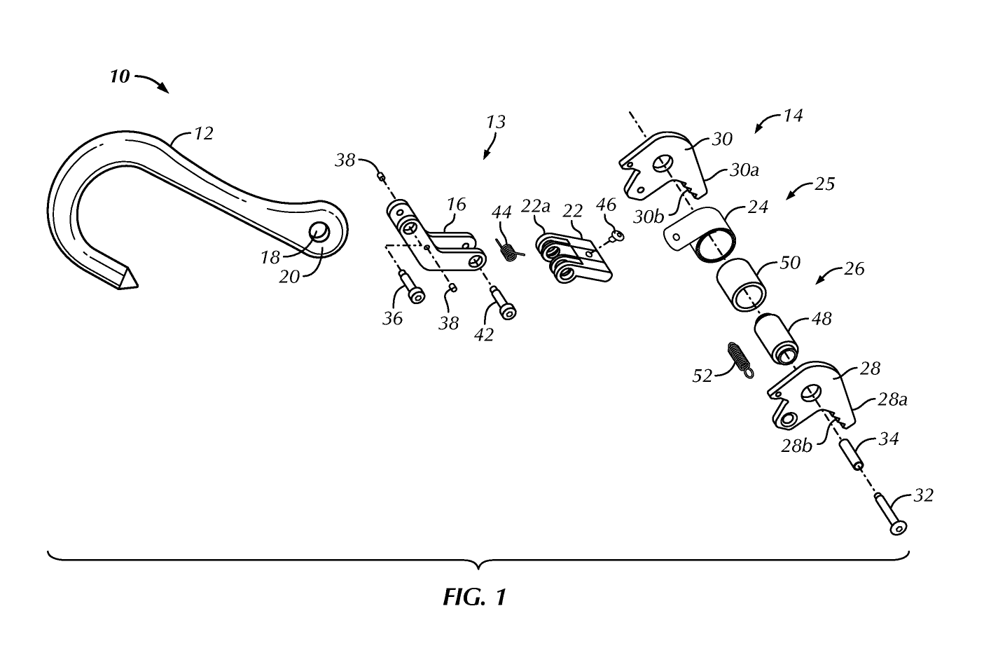

FIG. 1 is an exploded perspective view of a combination 10 of an anchor hook 12 of a type that serves as the support anchor for an escaping firefighter, along with the components of a preferred embodiment of an opposed spring-loaded anchor hook supporting device 14 in accordance with the present invention. As noted above, the anchor hook 12 shown in the figures is preferably of a type known in the art and commonly used by firefighters and others for escaping from a multistory building or other location. It will be appreciated by those skilled in the art that any other suitable anchor hook of the open type could alternatively be used with an opposed spring-loaded anchor hook supporting device 14 in accordance with the present invention. Therefore the present invention is not limited to use with the specific anchor hook 12 as shown or with any other specific anchor hook. Further, while the invention is described as being used by a firefighter in connection with an escape from a multistory building, it will be apparent that the present invention has applicability to many other types of uses, such as any type of rappelling activity, raising or lowering a person from any raised structure, including a mountain or any other situation in which an anchor hook or similar device may be used. Likewise, it should be clearly understood that the present invention may also be used by persons other than firefighters, such as paramedics, police officers or other service or rescue personnel or any other type of person who could make use of the invention.

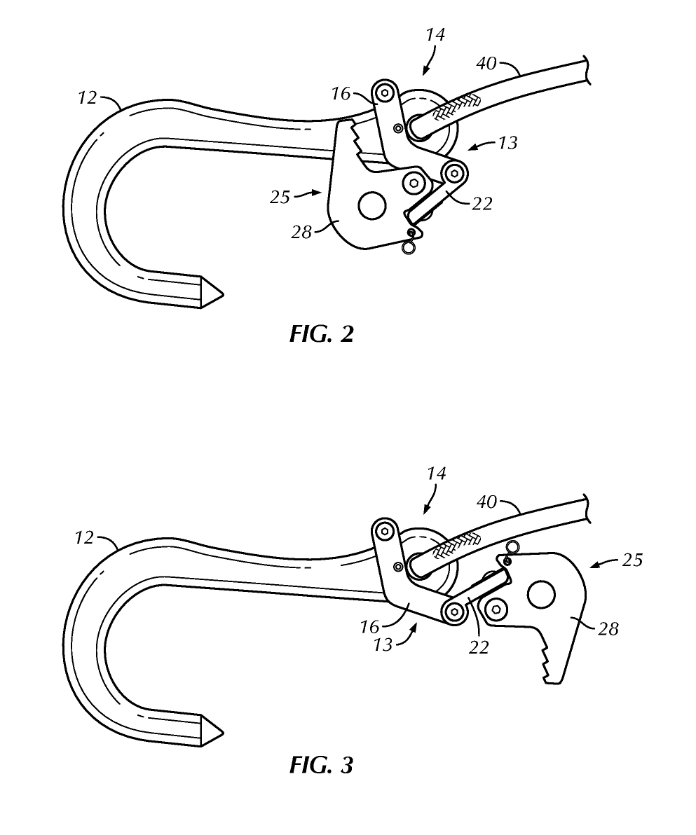

Referring again to FIG. 1, the components of the supporting device 14 include, an attachment assembly 13 comprising a generally L-shaped anchor hook shank support 16 which is pivotally attached at a first end or first leg to the eyelet opening 18 of the shank end 20 of the anchor hook 12 and a spring anvil 22. In the present embodiment, except as noted below, all of the components of the spring-loaded anchor hook supporting device 14 are made of a high strength, light weight material, such as steel, a steel alloy, some other metal or metal alloy, a composite material or the like, but that the components are not necessarily made of the same high strength material. A shoulder screw 36 and two sets screws 38 are used to hold the first end or first leg of the anchor hook shank support 16 to the shank end 20 of the anchor hook 12 in proper position proximate to the eyelet opening so the eyelet opening 18 is not impeded and the supporting rope or cable 40 (FIG. 2) secured to the shank end 20 of the anchor hook 12 is likewise not impeded. Preferably the first end of the shank support 16 is secured proximate or adjacent to the eyelet opening 18. Shoulder screw 36 buts up against the land surrounding the eyelet opening 18 both for positioning purposes and for preventing separation, while set screws 38 lock the shank support 16 in place. The second end or second leg of the shank support 16 is pivotally secured to a first end 22a of the spring anvil 22 which may pivot in the plane of the anchor hook 12 between a first position shown in FIG. 2 and a second position shown in FIG. 3. A shoulder screw 42 secures the first end of the spring anvil 22 to the second end or second leg of the shank support 16 and also serves as the pivot for the spring anvil 22. A small torsion spring 44 surrounds the shoulder screw 42 and serves to open up the supporting device 14 from its most compact, folded or storage position (see FIG. 2) to its opposed ready for normal use position (see FIG. 3).

A biasing member, in the present embodiment, a constant force spring 24 is pivotally secured at a first end, the exposed end, to a second end of the spring anvil 22 to pivot in a plane which is at right angles to the plane of the anchor hook 12. The second, coiled end of the constant force spring 24 is secured to an engagement assembly 25 which in the present embodiment comprises a drum assembly 26 upon which the second end of the constant force spring 24 is wound and a pair of grab hooks 28 and 30. The drum assembly 26 is supported on one side by a right side toothed grab hook 28 and on the other side by a left side toothed grab hook 30. The constant force spring 24 is preferably made of a high strength, light weight material of the type well known for making such springs, such as spring steel, a composite material or the like.

The two grab hooks 28 and 30, which are generally L-shaped, have matching tooth patterns on at least one surface and are spaced apart from each other and held together in proper aligned position by a screw 32 and a spacer tube 34. The first end of the constant force spring 24 is secured to the second end of the spring anvil 22 by a wide-headed screw 46. The screw 46 is not fully torqued down, but a thread-locker fluid of a type known in the art is used for locking the screw 46 in place with a slight clearance allowing the constant force spring 24 to rotate relative to the spring anvil 22 so the firefighter can exit to the side of an imaginary line that joins the point of the anchor hook 12 and the grab hooks 28 and 30. The wider rounded first end 22a of the spring anvil 22 serves to maintain the anchor hook 12 stably in a generally vertical plane.

At the second end of the constant force spring 24, the drum assembly 26 is comprised of a cylindrical inner drum 48 which may or may not rotate and a cylindrical outer drum 50 with an inner diameter that is at least slightly greater than the outer diameter of the inner drum 48 to provide a clearance so that the outer drum 50 may rotate around the inner drum 48 as the constant force spring 24 is drawn out from or into its coiled state (see FIG. 3). The inner drum 48 and the outer drum 50 are captured between the grab hooks 28 and 30. The constant force spring 24 is held substantially in place by a small extension spring 52 which pushes against the upper surface of the constant force spring 24 to maintain the constant force spring 24 in place without the danger of back-bending which could permanently degrade the force of the constant force spring 24. The reaction force of the constant force spring 24 against the force of the extension spring 52 helps to keep the noses 28a and 30a of each of the grab hooks 28 and 30 down to better facilitate the successful grabbing of a sill or other support member by the rows of grab hook teeth 28b and 30b. In order to prevent the constant force spring 24 from being completely pulled off the drum assembly 26, the innermost two turns of the constant force spring 24 can be welded, bonded or otherwise secured together or the second end of the constant force spring 24 could be secured to the outer drum 50 in any known manner before assembly of the supporting device 14.

FIG. 2 shows the combination 10 of the spring-loaded anchor hook supporting device 14 after being assembled to the anchor hook 12 by inserting and tightening the shoulder screw 36 proximate to the eyelet opening 18 after the shank support 16 is placed in the proper position on the shank end 20 of the anchor hook 12 and the set screws 38 are then tightened. The supporting device 14 is shown in the folded or storage position with the engagement assembly 25 adjacent to the attachment assembly 13 and tucked in close to the shank end 20 of the anchor hook 12 for easy storage in a pocket, pouch, backpack, utility belt or the like which may be worn by the firefighter.

FIG. 3 shows the assembled combination anchor hook and supporting device 10 in an unfolded, ready-for-use position with the engagement assembly 25 and the spring anvil 22 pivoted away from the anchor hook 12. In the unfolded position, the engagement assembly 25 may be easily grasped by a fireman when using the supporting device 14 to hold the anchor hook 12 in place on a window sill or other support member in proximate to the window.

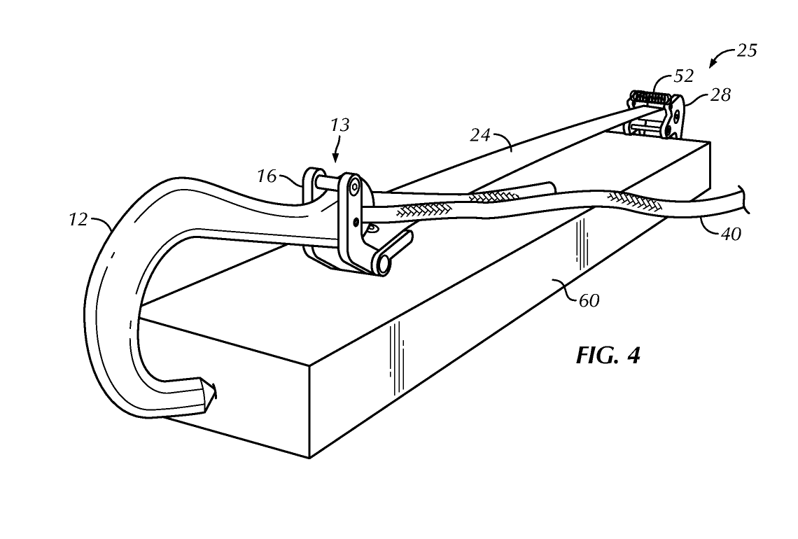

FIG. 4 is a perspective view of the assembled combination anchor hook and supporting device 10 held in place on a board 60 simulating a wide window sill. In actual use the window sill would be located near one side of a window opening so as to leave sufficient space on the other side of the window opening to permit the firefighter to escape out of the window. To install the combination anchor hook and supporting device 10, the escaping firefighter would first position the anchor hook 12 as shown in FIG. 4 so the steel point is pressed into the a first surface, such as a wooden apron below the inner side of the window sill or other suitable location. Then the firefighter would grasp the engagement assembly 25 and pull it away from the anchor hook 12 toward the exterior of the window sill to extend the constant force spring 24 until the noses 28a and 30a of the grab hooks 28 and 30 extend beyond the outer edge of the window sill. The grab hook teeth 28b and 30b would then be positioned at a second appropriate surface, preferably opposite the first surface, for example, the upper or lower edge of the outer surface of the window sill or some other suitable surface which is fixed with respect to the window sill, such as molding outside of the window or siding outside of the window, for the grab hook teeth 28b and 30b to engage. The firefighter would then slowly let the constant force spring 24 retract while making sure that the grab hook teeth 28b and 30b firmly grab and engage the second or outside surface of the window sill or the other surface. The spring force (approximately eight pounds in the present embodiment) of the constant force spring 24 would then pull the engagement assembly 25 and the attachment assembly 13 toward each other for holding the hook end of the anchor hook 12 on the first surface or inside surface of the window sill and keep the teeth 28b and 30b of the grab hooks 28 and 30 on the second surface or the other surface. With the opposed anchor supporting device 14 in place, the constant approximately 8 pound spring force of the constant force spring 24 keeps both the supporting device 14 and the attached anchor hook 12 securely in place on the window sill so the firefighter can quickly get out of the window opening without having to simultaneously hold onto or keep pressure on the anchor hook 12 to keep it from dislodging from the window sill. If it is necessary, the firefighter can readjust or reposition the anchor hook 12 prior to going out of the window without having to further touch the opposed anchor hook supporting device 14. Once the firefighter gets out of the window, the now taut rope or cable 40 lying alongside the opposed anchor supporting device 14 pulls the anchor hook 12 into alignment with the rope or cable 40, causing a pivoting between the spring anvil 22 and the constant force spring 24, and the opposed anchor supporting device 14 may also temporarily shift from being supported by both rows of grab hook teeth 28b and 30b to being supported by just one row of grab hook teeth until the firefighter's recovery or landing when the weight of the firefighter comes off the rope or cable 40 and the anchor hook 12 pivots back to being supported by and substantially aligning with the opposed anchor supporting device 14.

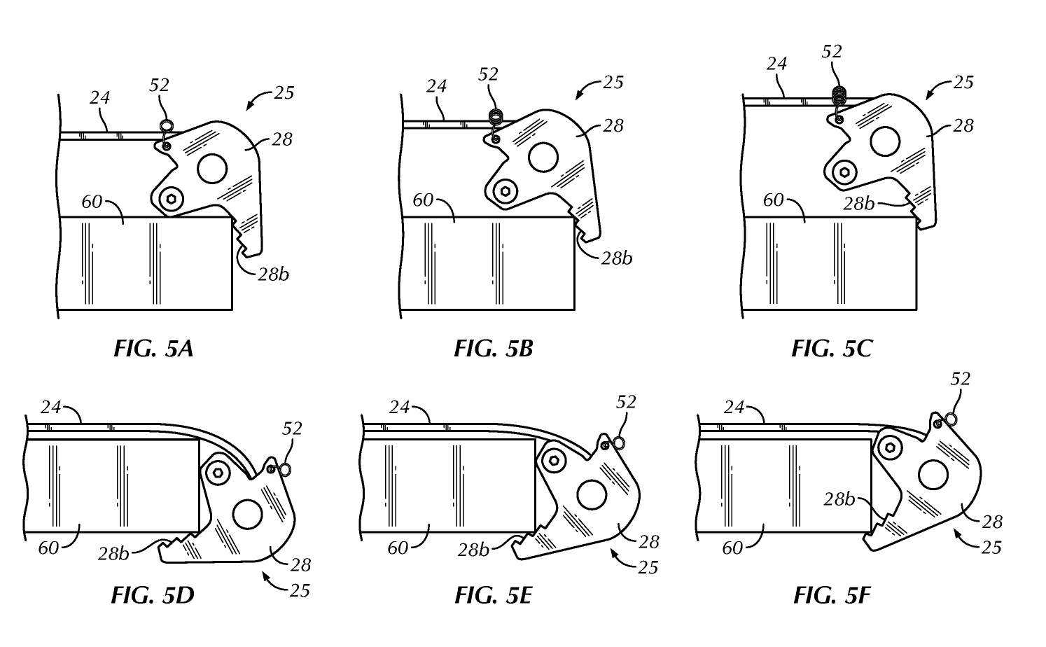

FIG. 5A shows how the upper teeth of the grab hook teeth 28b and 30b can grab onto the upper edge of the outer surface of the windowsill. FIG. 5B shows how the middle teeth of the grab hook teeth 28b and 30b can grab onto the upper edge of the outer surface of the window sill. Notice that the torque exerted by extension spring 52 keeps the grab hooks 28 and 30 from rotating backwards and slipping off of the window sill even when the bottom surface of each of the grab hooks 28 and 30 is elevated above the upper surface of the sill. FIG. 5C shows how the lower teeth of each of the grab hooks 28 and 30 can still grab onto the upper edge of the outer surface of the window sill without the grab hooks 28 and 30 back rotating and losing their grip.

FIG. 5D shows how the upper teeth of the grab hooks 28 and 30 can grab onto the lower edge of the outer surface of the window sill. This is a desirable position since it keeps the engagement assembly 25 totally out of the way of the escaping firefighter. FIG. 5E shows how the middle teeth of the grab hooks 28 and 30 can grab onto the lower edge of the outer surface of the window sill. This has an advantage over the previous position when there is less projection length of the outer sill at the lower edge. FIG. 5F shows how the lower teeth of the grab hooks 28 and 30 can still grab onto the lower edge of the outer surface of the window sill. This is important when there is very little projection of the outer sill beyond the outer wall of the structure.

Not shown in the drawings is the case where the grab hooks 28 and 30 grab onto the outer wall of the structure at the side of the window. This is entirely feasible because the very thin steel web of the constant force spring 24 can easily twist 90 degrees to accommodate such a situation.

Although the preferred embodiment of the opposing spring loaded anchor support for a firefighter's escape anchor hook has been described and specified in significant detail, usage with other devices and alternate arrangements and other applications still within the scope of the present invention are feasible. It will be appreciated by those skilled in the art that alternate uses may be found that differ from the described use, and that changes or modifications could be made to the above-described embodiment without departing from the broad inventive concepts of the invention. Therefore it should be appreciated that the present invention is not limited to the particular use or particular embodiment disclosed, but is intended to cover all uses and all embodiments within the scope or spirit of the described invention in accordance with the appended claims.

1. An anchor hook supporting device for use with an anchor hook having a hook end for engaging a first surface of a support member and a shank end which includes an eyelet opening for receiving a rope or cable, the supporting device comprising:
an attachment assembly for being secured to the shank end of the anchor hook;
an engagement assembly for engaging one of a second surface of the support member and another surface which is fixed with respect to the support member; and
a biasing member having a first end secured to the attachment assembly and a second end secured to the engagement assembly, the biasing member biasing the engagement assembly toward the attachment assembly to bias the shank end of the anchor hook and the engagement assembly toward each other for holding the hook end of the anchor hook on the first surface of the support member and the engagement assembly on the second surface of the support member or the other surface.

2. The supporting device as recited in claim 1 wherein the biasing member comprises a constant force spring.

3. The supporting device as recited in claim 2 wherein the engagement assembly includes at least one rotatable drum and wherein the second end of the constant force spring is initially coiled on the drum.

4. The supporting device as recited in claim 1 wherein the engagement assembly comprises at least one grab hook which includes at least one tooth for engaging the second surface of the support member or the other surface.

5. The supporting device as recited in claim 4 wherein the engagement assembly comprises two spaced apart, generally parallel grab hooks, each of the grab hooks including a plurality of teeth on at least one surface, the teeth for engaging the second surface of the support member or the other surface.

6. The supporting device as recited in claim 5 wherein the biasing member comprises a constant force spring and the engagement assembly further includes at least one rotatable drum located between the grab hooks and wherein the second end of the constant force spring is initially coiled on the drum.

7. The supporting device as recited in claim 1 wherein the second surface of the support member is opposite to the first surface.

8. The supporting device as recited in claim 1 wherein the attachment assembly is secured to the shank end of the anchor hook proximate to the eyelet opening.

9. The supporting device as recited in claim 8 wherein the attachment assembly comprises an anchor hook shank support having a first end which is secured to the shank end of the anchor hook and a spring anvil having a first end which is secured to a second end of the shank support and a second end which is secured to the biasing member.

10. A combined anchor hook and supporting device for holding the anchor hook on a support member comprising:
an anchor hook having a hook end for engaging a first surface of the support member and a shank end which includes an eyelet opening for receiving a rope or cable; and
a supporting device comprising an attachment assembly secured to the shank end of the anchor hook, an engagement assembly for engaging one of a second surface of the support member and another surface which is fixed with respect to the support member and a biasing member having a first end secured to the attachment assembly and a second end secured to the engagement assembly, the biasing member biasing the engagement assembly toward the attachment assembly to bias the shank end of the anchor hook and the engagement assembly toward each other for holding the hook end of the anchor hook on the first surface and the engagement assembly on the second surface of the support member or the other surface.

11. The combined anchor hook and supporting device as recited in claim 10 wherein the biasing member comprises a constant force spring.

12. The combined anchor hook and supporting device as recited in claim 11 wherein the engagement assembly includes at least one rotatable drum and wherein the second end of the constant force spring is initially coiled on the drum.

13. The combined anchor hook and supporting device as recited in claim 10 wherein the engagement assembly comprises two spaced apart, generally parallel grab hooks, each of the grab hooks including a plurality of teeth on at least one surface, the teeth for engaging the second surface of the support member or the other surface, the biasing member comprises a constant force spring and the engagement assembly further comprises at least one rotatable drum located between the grab hooks, the second end of the constant force spring being initially coiled on the drum.

14. A method of securing an anchor hook to a support member comprising:
providing an anchor hook having a hook end and a shank end which includes an eyelet opening for receiving a rope or cable;
securing a supporting device to the anchor hook, the securing device including an attachment assembly secured to the shank end of the anchor hook, an engagement assembly and a biasing member having a first end secured to the attachment assembly and a second end secured to the engagement assembly, the biasing member biasing the engagement assembly toward the attachment assembly;
placing the hook end of the anchor hook into engagement with a first surface of the support member;
pulling the engagement assembly away from the attachment assembly against the bias of the biasing member;
placing the engagement member into engagement with one of a second surface of the support member and another surface which is fixed with respect to the support member; and
releasing the engagement member so that the biasing member biases the shank end of the anchor hook and the engagement member toward each other to hold the hook end of the anchor hook on the first surface of the support member and the engagement assembly on the second surface of the support member or the other surface.
